(19) United States
(12) Patent Application Publication
(10) Pub. No.: US 2014/0166640 A1
(43) Pub. Date: Jun. 19, 2014

(54) SUPPORT FOR RESISTING RADIAL CREEP OF A HEATING ELEMENT COIL

(71) Applicant: SANDVIK THERMAL PROCESS INC, Sonora, CA (US)

(72) Inventor: Kevin Bryce Peck, Sonora, CA (US)

(73) Assignee: SANDVIK THERMAL PROCESS INC, Sonora, CA (US)

(21) Appl. No.: 14/105,807

(22) Filed: Dec. 13, 2013

Related U.S. Application Data
(60) Provisional application No. 61/736,956, filed on Dec. 13, 2012.

(51) Int. Cl. H05B 3/44; B23P 19/00

(52) U.S. Cl. CPC H05B 3/44; B23P 19/00
USPC 219/534; 29/428

(57) ABSTRACT

A support member for a heating element coil includes at least one support beam having an opposed distal and proximal end. The distal end being arranged to be anchored in insulation of the heating element and the proximal end oriented towards a center of loops of the heating element. At least one vertical support is disposed at the proximal end of the at least one support beam. The at least one vertical support forms a barrier surface limiting inward radial movement of loops of the heating element coil and a length of the vertical member determines a pitch of the loops of the heating element coil. An interlocking feature is located on the at least one vertical support. The interlocking feature interlocks the at least one vertical support to a respective adjacent vertical support to form a contiguous, aligned vertical support column. A variable surface is formed on at least a portion of a length of the at least one support beam. The variable surface provides an inward radial force to keep the loops of the heating element centered and at a minimum diameter.

### SUMMARY

In one embodiment a support member for a heating element coil includes at least one support beam having an opposed distal and proximal end. The distal end being arranged to be anchored in insulation of the heating element and the proximal end oriented towards a center of loops of the heating element. At least one vertical support is disposed at the proximal end of the at least one support beam. The at least one vertical support forms a barrier surface limiting inward radial movement of loops of the heating element coil and a length of the vertical member determines a pitch of the loops of the heating element coil. An interlocking feature is located on the at least one vertical support. The interlocking feature interlocks the at least one vertical support to a respective adjacent vertical support to form a contiguous, aligned vertical support column A variable surface is formed on at least a portion of a length of the at least one support beam. The variable surface provides an inward radial force to keep the loops of the heating element centered and at a minimum diameter.

In another embodiment, a method of controlling a position of a heating element coil within insulation of a heating element is provided. A plurality of support members are provided. Each support member includes at least one support beam having an opposed distal and proximal end. The distal end being arranged to be anchored in insulation of the heating element and the proximal end oriented towards a center of loops of the heating element. At least one vertical support is disposed at the proximal end of the at least one support beam. The at least one vertical support forms a barrier surface limiting inward radial movement of loops of the heating element coil and a length of the vertical member determines a pitch of the loops of the heating element coil. An interlocking feature is located on the at least one vertical support. The interlocking feature interlocks the at least one vertical support to a respective adjacent vertical support to form a contiguous, aligned vertical support column A variable surface is formed on at least a portion of a length of the at least one support beam. The variable surface provides an inward radial force to keep the loops of the heating element centered and at a minimum diameter. The plurality of vertical supports are interlocked to form the vertical support column and the loops of the heating element coil are mounted in the vertical support column, wherein the variable surface provides an inward radial force to keep the loops of the heating element centered and at a minimum diameter.

In yet another embodiment a support member for a heating element coil includes at least one support beam having an opposed distal and proximal end. The distal end is arranged to be anchored in insulation of the heating element and the proximal end oriented towards a center of loops of the heating element. At least one vertical support is connected with the proximal end of the at least one support beam. The at least one vertical support forms a barrier surface limiting inward radial movement of loops of the heating element coil and a length of the vertical support determines a pitch of the loops of the heating element coil. A variable surface is formed on a length of the at least one support beam, the variable surface providing an inward radial force to keep the loops of the heating element centered and at a minimum diameter.

These and other objects, features, aspects, and advantages will become more apparent from the following detailed description of the preferred embodiments relative to the accompanied drawings, in which:

### BRIEF DESCRIPTION OF THE DRAWINGS

FIG. 1 is a perspective view of a known heat processing furnace.

FIG. 2 is a perspective view of a support member for a heating element coil.

FIG. 3 is a side view of the support member of FIG. 2 along with a heating coil and insulation of a heating furnace.

FIG. 4 is a top view of a heating coil illustrating the arrangement of the support members of the embodiment of FIG. 2.

FIG. 5 is a side view of another embodiment of a support member for a heating element coil.

FIG. 6 is a cross-sectional view of the support arrangement for the support member of FIG. 5.

FIG. 7 is a cross-section of a known heating coil and support arrangement.

FIG. 8 is a side view of yet another embodiment of a support member for a heating element coil.

FIG. 9. is a perspective view of another embodiment of a support member for a heating element coil.

FIG. 10 is a side view of another embodiment of a support member for a heating element coil.

FIG. 11 is a perspective view of still another embodiment of a support member for a heating element coil.

FIG. 12 is a perspective view of yet another embodiment of a support member for a heating element coil.

FIG. 13 illustrates a method according to the above embodiments.

### DETAILED DESCRIPTION

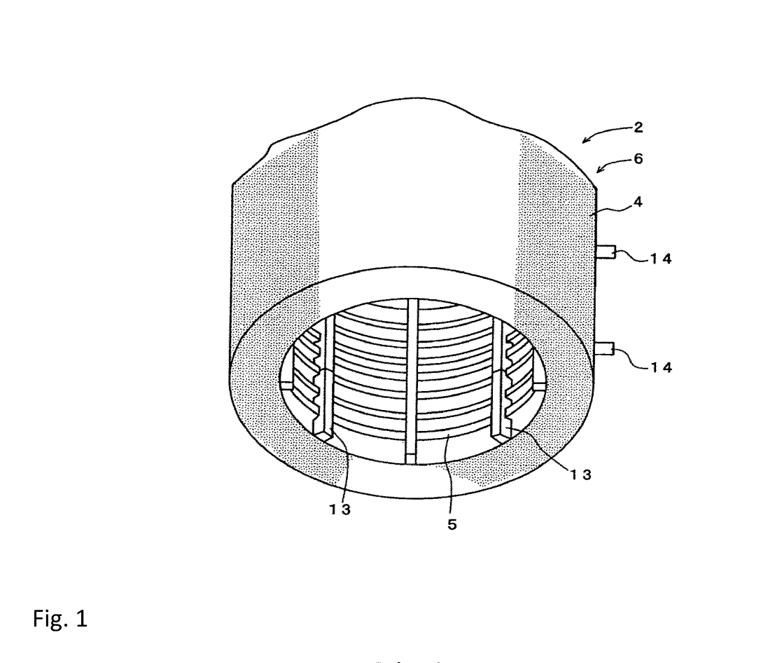

Resistance heating element assemblies are widely used in thermal processing equipment. One of the more common configurations consists of a helically wound coil of wire surrounded by a cylinder of insulating material. These assemblies can be divided into two general groups, those having a central axis of the coil that is oriented horizontally are commonly referred to as horizontal heating element assemblies, while those where the central axis of the coil is oriented vertically are commonly referred to as vertical heating element assemblies, see FIG. 1. While the present disclosure illustrates vertical heating element assemblies, it should be appreciated that variations hereof can be applied to horizontal heating elements as well.

It is well known that there are two basic failure mechanisms for this type of heating element assembly. One is based on the heating element material life. This may be influenced by external contamination of the material, but is generally a function of oxidation life and driven by the material metallurgy and quality of the base alloy materials. The second is structural failures. These are influenced by process cycle times and temperatures, rates of temperature increase/decrease and heat losses. The underlying basic issues are generally the same, material strength at increased temperatures (deformation) and permanent elongation.

It is known that the FeCrAl alloy forms aluminum oxide on its outer surface at elevated temperatures. Furthermore, it is the presence of this oxide layer that protects the material from forming other oxides and nitrides that would cause the material to fail. In addition, the oxide layer, in combination with grain growth in the alloy, gives the material its creep strength and form stability. Unfortunately, the thermal expansion of the oxide and alloy are not quite the same. While the FeCrAl alloy materials exhibit thermal expansion of approximately 15×10⁻⁶° C. over the range of about 20 to about 1000° C., the protective oxide exhibits thermal expansion closer to 8×10⁻⁶° C. over the same range. Under transient thermal conditions, tensile and compressive stresses can fracture the oxide. When this occurs, additional aluminum is consumed from the alloy to form fresh oxide to “heal” the fractures. When the stresses become high enough, spallation can occur where areas of the oxide are ejected from the surface of the wire. The newly exposed material will form oxide by consuming some of the aluminum from the alloy and oxidizing it at the surface. When the material no longer has enough aluminum in the alloy matrix to properly heal this damage, then it is declared that the material is at its end of oxidation life.

This cyclical stressing and healing of the material causes a reduction in cross-section and permanent elongation in the material. Advances in material science and metallurgy have helped to minimize the permanent elongation and improved form stability by enhancing grain growth in the material, but they have not been entirely eliminated. Furthermore, any external mechanical strain placed on the material tends to exacerbate the elongation.

As the material expands during heating, the diameter of the coil increases. If the insulating materials are applied directly on the outer diameter (OD) of the coil, then the thermal expansion causes the coil to push against the insulation creating stress in the material. While this effect is much less significant in smaller diameter coils, it can be imagined that in large coils, such as those greater than about 250 mm, the expansion can be quite substantial and result in considerable stress on the resistance material. The stress created as a result of thermal expansion can result in immediate distortion of the coil as well as accelerating the permanent elongation of the material.

One approach to reducing the risk of stress due to thermal expansion is to position the insulating materials some distance from the OD of the coil. The annular space is typically chosen to accommodate the expected thermal expansion as well as some anticipated quantity of permanent elongation in the material which translates into an increase in OD. This annular space requirement is typically between about 5 mm and about 35 mm, and more typically between about 5 mm and about 15 mm. Each loop of the helical coil is supported at multiple locations around its circumference, and the insulating material is fabricated with an ID greater than the coil OD, creating the desired annular space. Unfortunately, there are other factors that can have negative impact on the heating element coil if this approach is taken.

In the case of a vertical heating element configuration, as shown in the heating furnace of FIG. 1, the force of gravity pulling on the mass of the coil creates a downward force that is translated to linear force vector by the product of the angle of the heating element material to its circumferential support members. This force creates a preference for the material to creep towards the bottom. Without any counter-measures, the loops at the bottom of the coil tend to expand while the upper loops contract in diameter.

U.S. Patent Application No. 2011/0315673, assigned to the assignee of the present disclosure, discloses keeping coil loops consistent by interlocking the loops at support points while allowing the entire column of supports to move in unison. This is an effective method for controlling the creep, but is somewhat limited to higher temperature applications that have a thicker insulation profile since the assembly occupies a relatively thick profile within the insulation.

The creep issue is also discussed in U.S. Pat. No. 8,134,100, where it is suggested that a number of fixed plates can be attached to the heating element coil adjacent to some of the spacer support locations, on the side corresponding to the higher vertical position of the helical loop. This solves the problem of coil creep, but introduces issues as how to attach the fixed plates without damaging the coil, introducing thermal non-uniformity and subsequent coil deformation at the attachment points. In addition, this method is labor intensive, adding to the production costs of the assembly.

Additionally, U.S. Pat. No. 8,134,100 discloses a configuration where a series of tubular members that are declined at an angle of 50 to 200 degrees to allow the individual coil loops to move radially inward when cooled and reduce tensile stresses on the coil. While this relatively large angle of inclination can reduce tensile stresses as the coil is cooled, it can also present significant impingement forces on the OD of the coil as it expands and lead to distortion.

U.S. Patent Application No. 2009/0194521 also discloses the use of fixed plates that act as movement prevention members dispersed throughout the coil with no significant differences as to those disclosed in U.S. Pat. No. 8,134,100. These movement prevention members present the same issues with attachment and coil distortion as in the previous application.

Since none of these solutions present an optimal solution for managing creep and freely supporting the helical coil of resistance material in a mid-temperature, low mass heating element assembly, there is a need for such a solution in the industry.

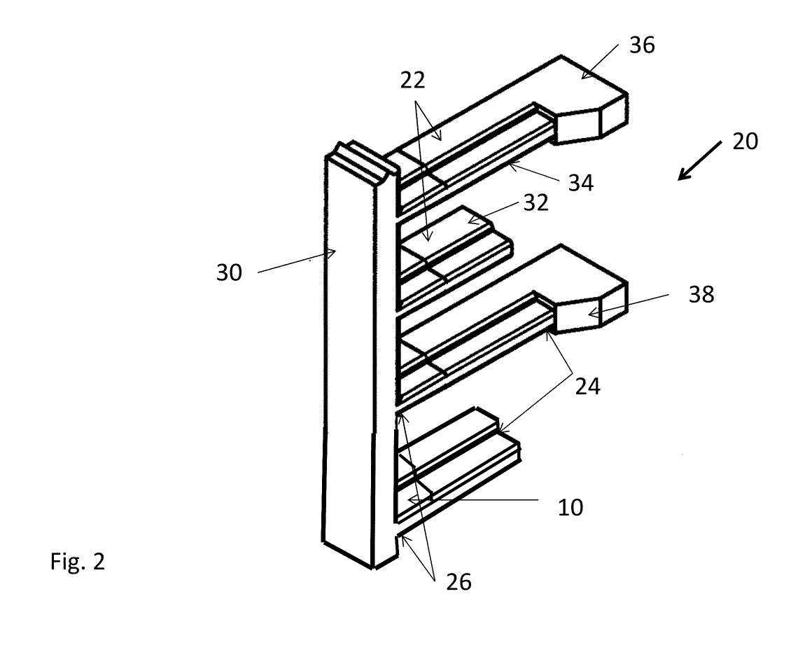

The present support member allows for minimally supporting a heating coil in order to reduce stress on the element material and obtain maximum product life. Referring to FIG. 2, a first embodiment of a support member or spacer 20 for a heating coil is shown. Support member 20 may have at least one individual support beam 22, or multiple beams 22 per piece in order to increase the rigidity of the assembly and reduce assembly time. Each beam 22 has an opposed distal end 24 and a proximal end 26.

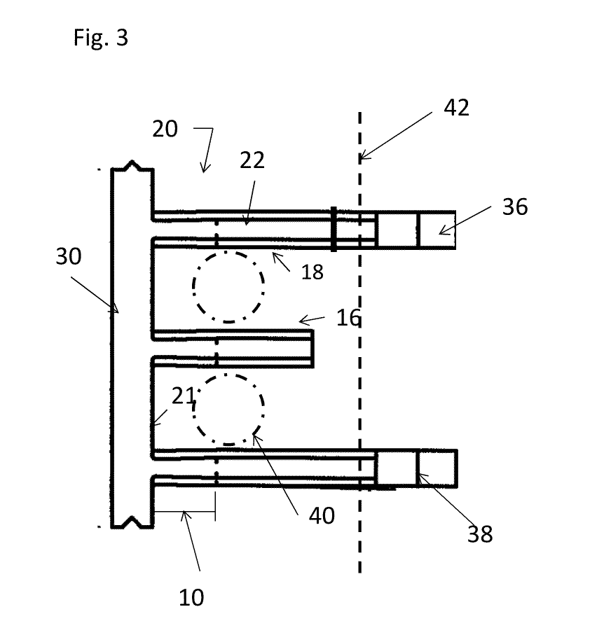

As shown in FIGS. 2 and 3, proximal end 26 each of the beams 22 have a variable surface 10, which will be described in further detail herein, and terminate in a vertical support column 30 that prevents a heating element coil 40 (FIG. 3) from moving inward beyond the vertical support member's inner (where the proximal end of the support member joins the vertical support member) surface 21. The vertical support column determines the pitch of the loops within the coil and may be of varying lengths in order to create various preferential pitches within the heating element coil. The pitch is defined by the distance from the plane containing a top flat surface 32 of the beam to a plane containing a bottom flat surface 34 of a corresponding beam. The pitch dimension in turn determines the distance between individual circular loops 40 in the coil assembly. Support member 20 is shown in FIG. 3 with three beams 22 for simplicity of view. It should be appreciated that the embodiments of the support disclosed herein can incorporate any number of beams and should not be limited to the number illustrated.

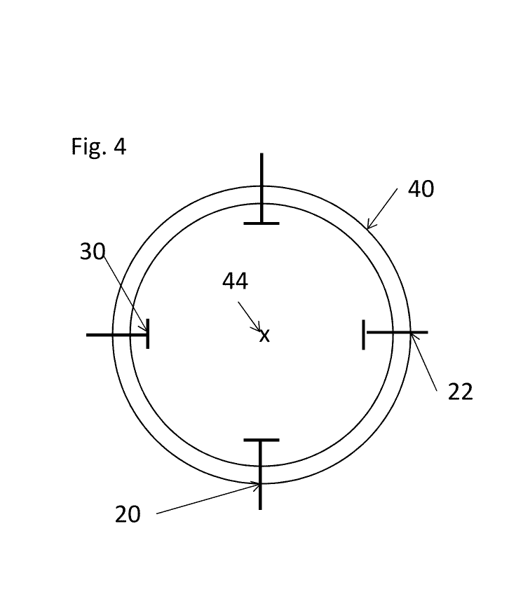

At least some of support beams 22 have an anchoring portion 36 at the distal end to anchor the beam within insulation 42 of a heating furnace. It should be appreciated that the embedded anchoring portion can be formed into the insulation as it is molded, fit into a groove in the insulation whether it is monolithic or comprised of individual panels. In the case where the insulation is constructed from multiple panels, the embedded portion 36 may be installed at the junction of two panels (not shown). Optionally, embedded portion 36 may be cemented in place to secure it within the insulation. FIG. 4 illustrates a cross-section of the support members of FIG. 3 arranged about insulation 40.

In the case where the insulation is to be formed around the anchor during a molding process, it is preferential to have the surface of the retention feature incorporate an angular or radial feature 38 to insure the insulation forms fully round the anchor. In cases where the anchor will be embedded in the insulation after vacuum forming, it is alternately desirable to have the anchor at the distal end more abrupt, such as a plate perpendicular to the axis of the support beams. This configuration creates the highest resistance to extraction of the support member from the insulation.

As shown in FIG. 3, variable surface 10 can be located on an underside 18 and an upperside 16 of a support beam 22, such that the support member can be installed with either side of the support beam facing upward in order to accommodate clockwise and counterclockwise wound heating element coils.

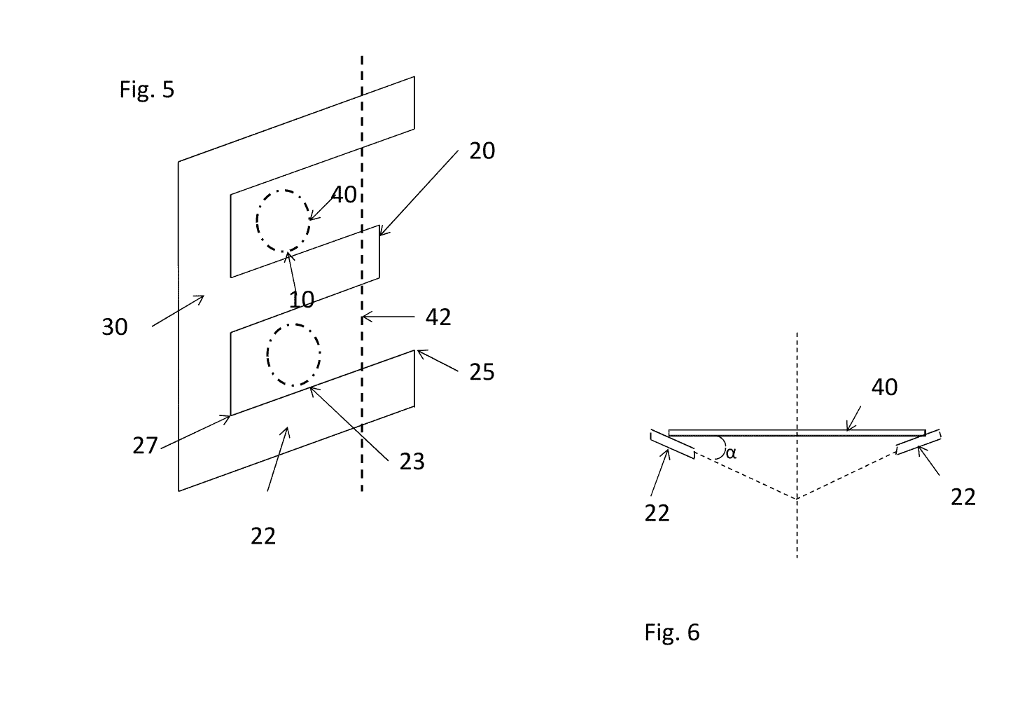

The profile of support beams 22 incorporate variable surface 10 formed by an inclined surface 23 having a gradation along a portion of the length of the variable surface. The profile of the variable surface may be either linear or non-linear along the length of the gradation. FIG. 5 illustrates one embodiment of support member 20 having a variable surface 10 with a linear gradation along the length thereof. Beams 22 are inclined with respect to vertical support 30 such that the gradation has a lowest point 27 and a highest point 25.

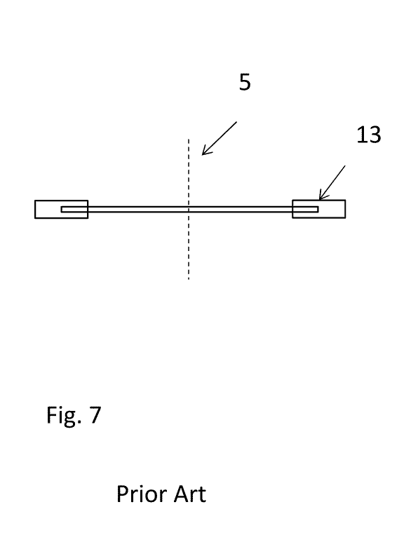

As shown in FIG. 6, beams 22 extend at an angle α from the horizontal plane. Angle α can be from zero to about 45°. In contrast, beams 13 of the support members of the prior art extend in a radially outward direction as shown in FIG. 7. Referring again to FIG. 6, the support members form a conical spiral around the center, i.e. beams 22 do not extend radially outward since they do not intersect the center line at right angles.

The magnitude of the gradation can be from about 0.1 mm to about 5 mm and more preferably 0.5 mm to about 2 mm. The length of the variable surface length is about 5 mm to about 35 mm. However, it should be appreciated that the disclosed embodiments need not be limited to any specific dimensions and can vary depending upon application.

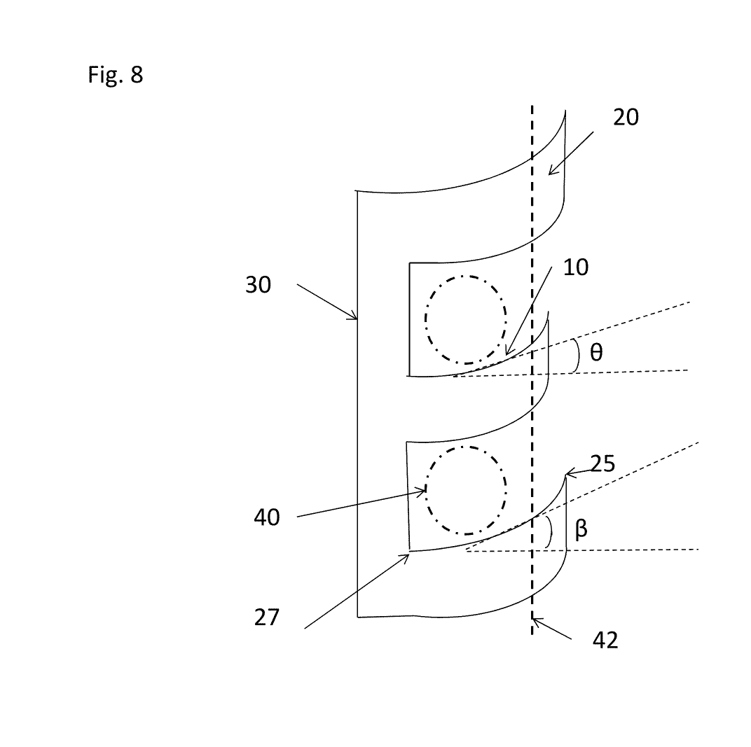

FIG. 8 illustrates an embodiment of support member 20 wherein beams 22 have a variable surface 10 with a non-linear gradation. As described above with reference to the embodiments of FIGS. 1-7, the non-linear gradation extends from a lowest point 27 to a highest point 25 with a magnitude of from about 0.1 mm to about 5 mm and more preferably about 0.5 mm to about 2 mm and a length of about 5 mm to about 35 mm.

Non-linear gradations can be used to supply more or less force to the outside diameter of the coil at different points in its useful life. For example, as the coil elongates over its useful life, the amount of force can be increased with additional gradation occurring toward the fiber surface. The angle created by the graded surface normal to the horizontal plane of the support member center should not exceed approximately 45°, since there is increased resistance to normal thermal expansion and risk of the coil distorting. Additionally, if the gradation of the surface is too extreme, then the coil loop can become impinged at on one side and be stuck at an angle, increasing the risk of the loop touching adjacent loops and causing an electrical short circuit or compromising the thermal uniformity of the heating element surface.

Additionally, the profile can be varied preferentially along the length of the coil to maximize this benefit. For example, the degree of gradation can be greater at the bottom of the coil than the top in order to provide a greater resistance to expansion at the bottom. Referring again to FIG. 8, the gradation on a lower beam 22 can have an angle β and an upper beam can have a non-linear gradation with an angle of θ, wherein angle β is larger than angle θ, but not greater than about 45°.

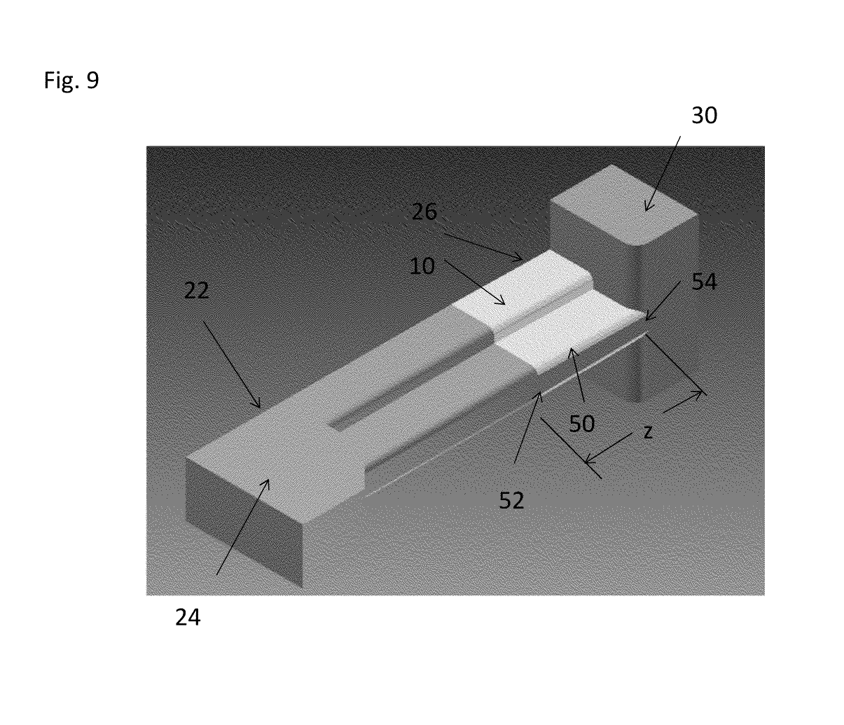

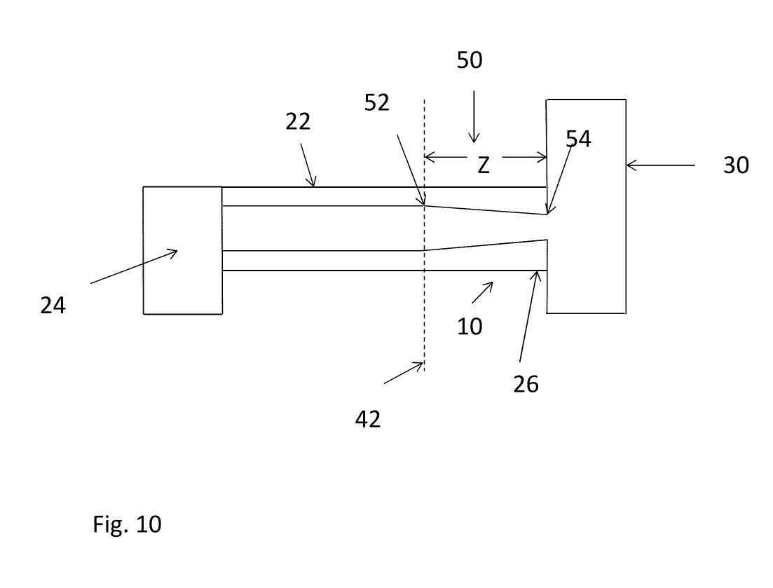

Referring to FIGS. 9 and 10, another embodiment of a support member 20 is shown. Support member 20 is shown as an individual support beam 22. A portion Z of the variable surface 10 of support beams, residing between the inner surface of vertical support 30 at proximal end 26 and the area where the support member exits the inner surface of the insulation 42, has a variable radius 50. Variable radius 50 has a minimum radius 52 and a maximum radius 54. Maximum radius 54 is located at proximal end 26 and minimal radius 52 is positioned near distal end 24 in order to create a slight vector of force inward on the outside diameter of the heating element coil loops, i.e., the larger radius creates a lower supporting surface at the proximal end while the smaller radius creates a higher supporting surface at the end of the variable surface oriented towards the distal end.

This force partially opposes the natural tendency of the heating element material to creep downward while increasing the diameter of the coil loops. The amount of gradation is chosen to be enough to reduce creep, while slight enough not to cause any negative effects from impingement of the OD of the coil during thermal expansion. The magnitude of gradation is selected be some multiple, (such as about 1 to about 5 times the change in vertical position of the heating element coil material from one support column to the next (loop pitch/number of columns) Loop pitch refers to the distance between two adjacent points on the coil circumference separated by 360 degrees of coil distance or in other words the distance between two axially coincident points on the coil spiral between adjacent loops. In practical applications, as described above, the magnitude of gradation will be from about 0.1 mm to about 5 mm and more preferably from about 0.5 mm to about 2.0 mm.

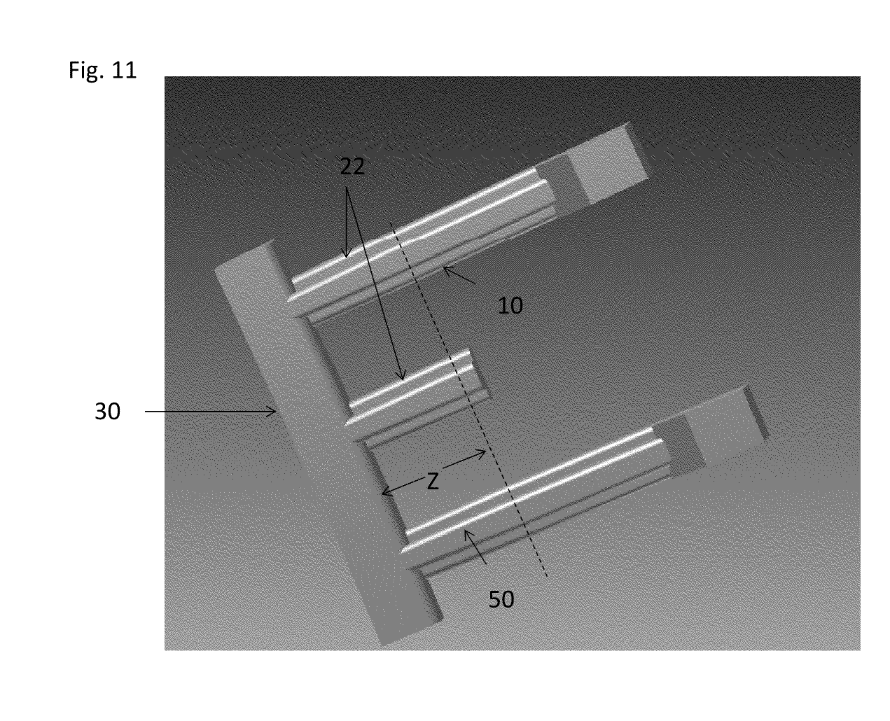

FIG. 11 is similar to the embodiment of FIGS. 9 and 10 but has a plurality of beams 22. Each beam has a portion Z having a variable profile as described above.

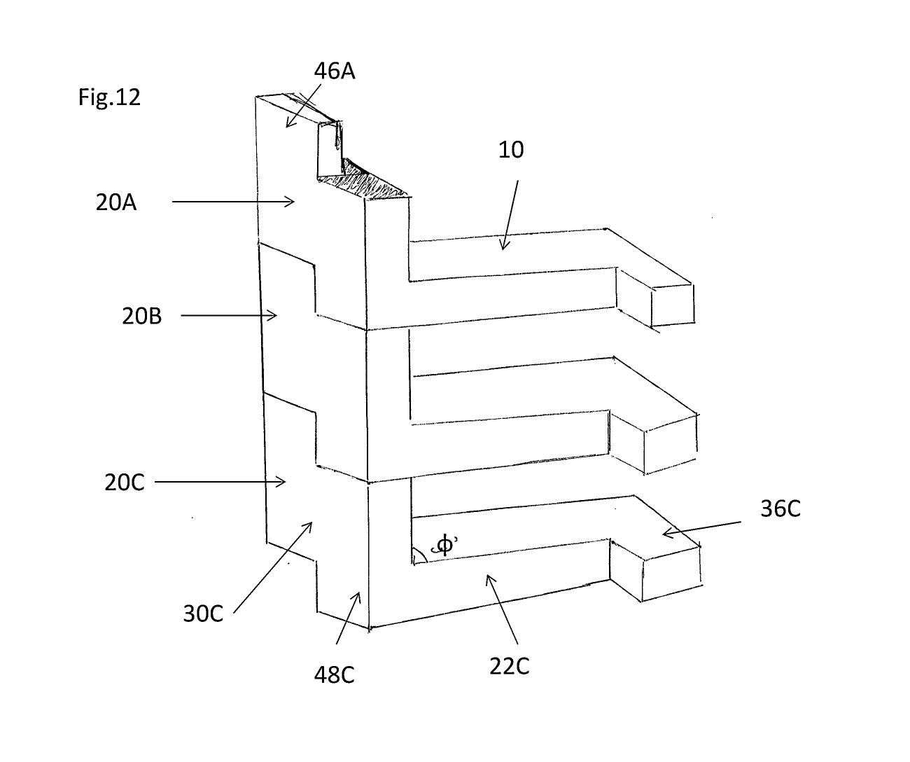

FIG. 12 illustrates another embodiment of a support member. In this embodiments a plurality of interlocking support members 20A-20C are provided. It should be appreciated that numerous members can be provided. Each vertical support includes an upper interlocking portion 46 and a lower interlocking portion 48. When stacked interlocking portions 46 and 48 of adjacent support members connect to form a unitary column.

The support members are preferentially constructed of an aluminum-silicate ceramic to provide good mechanical performance at the typical process temperatures and electrical resistance. The material may be either fully dense (vitreous) ceramic or semi-porous material. The semi-porous material has the added advantage of reducing the thermal mass of the heating element, albeit at the cost of some mechanical strength.

The configuration of the disclosed embodiments yields preferential force vectors to return the loops of the coil to the radial center of the assembly, providing resistance to mechanical creep, while avoiding excessive impingement forces on the smaller gauge heating element resistance wire, for example, typically 2.5 mm to 5 mm diameter.

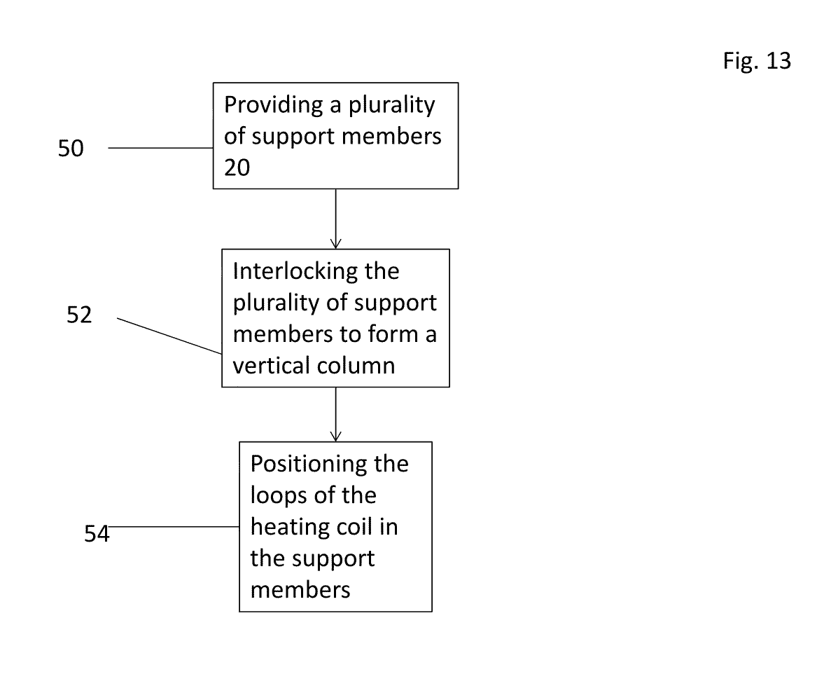

Referring to FIG. 13, a method according to the present embodiments discloses the steps of providing a plurality of support members 20 at 50. The support members are then connected in step 52 and as described above to form a vertical support member. Loops of the heating element can then be positioned in the support members as shown at 54. The variable surface of the support beams returns the loops of the coil to the radial center of the assembly, providing resistance to mechanical creep, while avoiding excessive impingement forces. Moreover, the coil diameter is controlled by the vertical spacing of the members.

Although the present disclosure has been described in relation to particular embodiments thereof, many other variations and modifications and other uses will become apparent to those skilled in the art. It is preferred therefore, that the present disclosure be limited not by the specific disclosure herein, but only by the appended claims.

What is claimed is:

1. A support member for a heating element coil comprising:
at least one support beam having an opposed distal and proximal end, the distal end being arranged to be anchored in insulation of the heating element and the proximal end being oriented towards a center of loops of the heating element;
at least one vertical support disposed at the proximal end of the at least one support beam, wherein the at least one vertical support forms a barrier surface limiting inward radial movement of loops of the heating element coil and a length of the at least one vertical support determines a pitch of the loops of the heating element coil;
an interlocking feature located on the at least one vertical support, wherein the interlocking feature interlocks the at least one vertical support to a respective adjacent vertical support to form a contiguous, aligned vertical support column; and
a variable surface formed on at least a portion of a length of the at least one support beam, the variable surface providing an inward radial force to keep the loops of the heating element centered and at a minimum diameter.

2. The support member of claim 1, wherein the variable surface has a variable radius along at least the portion of the length of the at least one support beam, the variable radius having a maximum radius and a minimum radius.

3. The support member of claim 2, wherein the maximum radius is located at the proximal end of the at least one support beam and the minimal radius is positioned toward the distal end of the at least one support beam.

4. The support member of claim 2, wherein the variable radius is between about 0.1 mm to about 5 mm.

5. The support member of claim 2, wherein the variable radius is between about 0.5 mm to about 2 mm.

6. The support member of claim 1, wherein the variable surface comprises an inclined surface having a gradation disposed along the portion of the length of the at least one support beam, the gradation having a lowest point and a highest point.

7. The support member of claim 6, wherein the lowest point of the gradation is located at the proximal end and the highest point of the gradation is located near the distal end.

8. The support member of claim 6, wherein the gradation of the inclined surface is about 0.1 mm to about 5 mm.

9. The support member of claim 6, wherein the gradation of the inclined surface is about 0.5 mm to about 2 mm.

10. The support member of claim 6, wherein the gradation of the inclined surface is linear.

11. The support member of claim 6, wherein the gradation of the inclined surface is non-linear.

12. The support member of claim 1, wherein the variable surface length is about 5 mm to about 35 mm.

13. The support member of claim 1, wherein the variable surface length is about 5 mm to about 15 mm.

14. The support member of claim 1, wherein variable surface is located on an underside and an upperside of the at least the support beam, such that the support member may be installed with either side of the support beam facing upward in order to accommodate clockwise and counterclockwise wound heating element coil.

15. The support member of claim 1, comprising a single support beam per vertical support member.

16. The support member of claim 1, comprising a plurality of support beams per vertical support member.

17. The support member of claim 16, wherein the distal end of one or more of the at least one support beams is partially embedded in the element insulation.

18. A method of controlling a position of a heating element coil within insulation of a heating element, the method comprising the steps of:
providing a plurality of support members, each support member including at least one support beam having an opposed distal and proximal end, the distal end being arranged to be anchored in the insulation of the heating element and the proximal end being oriented towards a center of loops of the heating element; at least one vertical support disposed at the proximal end of the at least one support beam, wherein the at least one vertical support forms a barrier surface limiting inward radial movement of loops of the heating element coil and a length of the vertical support determines a pitch of the loops of the heating element coil; an interlocking feature located on the at least one vertical support, wherein the interlocking feature interlocks the at least one vertical support to a respective adjacent vertical support to form a contiguous, aligned vertical support column; and a variable surface formed on a portion of a length of the at least one support beam, the variable surface providing an inward radial force to keep the loops of the heating element centered and at a minimum diameter;
interlocking a plurality of vertical supports to form the vertical support column; and
mounting the loops of the heating element coil in the vertical support column, wherein the variable surface provides an inward radial force to keep the loops of the heating element centered and at a minimum diameter.

19. The method of claim 18, wherein the variable surface has a variable radius along at least the portion of the length of the at least one support beam, the variable surface having a variable radius with a maximum radius of the variable radius being located at the proximal end and a minimum radius of the variable radius being positioned toward the distal end.

20. The method of claim 18, wherein the variable radius is between about 0.1 mm to about 5 mm.

21. The method of claim 18, wherein the variable radius is between about 0.5 mm to about 2 mm.

22. The method of claim 18, wherein the variable surface comprises an inclined surface having a gradation disposed along at the least portion of the length of the at least one support beam, wherein a lowest portion of the gradation is located at the proximal end and a highest portion of the gradation is located near the distal end.

23. The method of claim 22, wherein the gradation of the variable surface is about 0.1 mm to about 5 mm.

24. The method of claim 22, wherein the gradation of the variable surface is about 0.5 mm to about 2 mm.

25. The method of claim 22, wherein the gradation of the variable surface is linear.

26. The method of claim 22, wherein the gradation of the variable surface is non-linear.

27. The method of claim 18, wherein the portion of the variable surface length is about 5 mm to about 35 mm.

28. The method of claim 18, wherein the variable surface length portion is about 5 mm to about 15 mm.

29. The method of claim 18, wherein variable surface is located on an underside and an upper side of the at least the support beam, such that the support member may be installed with either side of the support beam facing upward in order to accommodate clockwise and counterclockwise wound heating element coil.

30. The method of claim 18, comprising a single support beam per support member.

31. The method of claim 18, comprising a plurality of support beams per support member.

32. The method of claim 31, wherein the distal end of one or more of the at least one support beams are only partially embedded in the element insulation.

33. A support member for a heating element coil comprising:
at least one support beam having an opposed distal and proximal end, the distal end being arranged to be anchored in insulation of the heating element and the proximal end being oriented towards a center of loops of the heating element;
at least one vertical support disposed at the proximal end of the at least one support beam, wherein the at least one vertical support forms a barrier surface limiting inward radial movement of loops of the heating element coil and a length of the vertical support determines a pitch of the loops of the heating element coil; and
a variable surface formed along at least a portion of a length of the at least one support beam, the variable surface providing an inward radial force to keep the loops of the heating element centered and at a minimum diameter.

34. The support member of claim 33, further comprising a plurality of vertical supports.

35. The support member of claim 34, further comprising an interlocking feature located on each of the vertical supports, wherein the interlocking feature interlocks a vertical support to a respective adjacent vertical support to form a contiguous, aligned vertical support column.

36. The support member of claim 35, wherein each vertical support includes an upper interlocking portion and a lower interlocking portion, said upper and lower interlocking portions being connectable to form the contiguous, aligned vertical support column.

37. The support member of claim 33, wherein the variable surface is formed by incorporating a variable radius along at least a portion of a length of the at least one support beam, the variable surface having a variable radius.

38. The support member of claim 37, wherein the variable surface has a maximum radius located at the proximal end and a minimum radius of the variable radius being positioned toward the distal end.

39. The support member of claim 38, wherein the variable radius is about 0.1 mm to about 5.0 mm.

40. The support member of claim 38, wherein the variable radius is about 0.5 mm to about 2.0 mm.

41. The support member of claim 33, wherein the variable surface comprises an inclined surface having a gradation disposed along at least a portion of the length of the at least one support beam.

42. The support member of claim 41, wherein a lowest point of the gradation is located near the proximal end of the at least one support beam and a highest point of the gradation is located near the distal end.

43. The support member of claim 33, wherein the at least one beam extends at an angle from the at least one vertical support.

44. The support member of claim 43, wherein the angle is about 0 to about 45°.

45. The support member of claim 43, wherein the variable surface has a linear gradation along at least a portion of the length.

46. The support member of claim 43, wherein the variable surface has a non-linear gradation along at least a portion of the length.

47. The support member of claim 46, wherein the non-linear gradation is from about 0 to about 45°, such that depending on the gradation more or less force can be applied to the outside diameter of the coil as the coil elongates over its useful life.

48. The support member of claim 33, further comprising a plurality of support beams, wherein each of said support beams has a different variable surface.

49. The support member of claim 48, wherein a lower support beam supporting a bottom loop of the coil can have a gradation that is greater than a gradation of an upper support beam supporting an upper loop of the coil.

50. The support member of claim 49, wherein the lower and upper support beam each extend from the vertical support column at an angle.

51. The support beam of claim 50, wherein the angle of the lower support beam is greater than the angle of the upper support beam.

52. The support beam of claim 51, wherein the angle of the lower support beam is equal to or less than about 45°.

53. The support member of claim 50, wherein the gradation of the lower support beam and the gradation of the upper support beam are linear.

54. The support member of claim 50, wherein the gradation of the lower support beam and the gradation of the upper support beam are non-linear.

55. The support member of claim 41, wherein the gradation of the variable surface is about 0.1 mm to about 5.0 mm.

56. The support member of claim 41, wherein the gradation of the variable surface is about 0.5 mm to about 2.0 mm.

57. The support member of claim 41, wherein the gradation of the variable surface is linear.

58. The support member of claim 41, wherein the gradation of the variable surface is non-linear.

59. The support member of claim 41, wherein the length of the gradation is about 5 mm to about 35 mm.

60. The support member of claim 41, wherein the length of the gradation is about 5 mm to about 15 mm.

61. The support member according to claim 33, wherein the variable surface is located on both an underside and an upper side of the at least one support beam, such that the support member may be installed with either side of the at least one support beam facing upward in order to accommodate clockwise and counterclockwise wound heating element coils.

62. The support member according to claim 33, wherein there is a single support beam per support member.

63. The support member according to claim 33, wherein the support member is an aluminum-silicate ceramic.

64. The support member according to claim 48, wherein one or more of the support beams are only partially embedded in the heating element insulation.
